(19) United States
(12) Patent Application Publication
(10) Pub. No.: US 2010/0118285 A1
(43) Pub. Date: May 13, 2010

(54) EXPOSURE APPARATUS, SUBSTRATE PROCESSING APPARATUS, LITHOGRAPHY SYSTEM, AND DEVICE MANUFACTURING METHOD

(75) Inventor: Hiroyuki Miyazaki, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/616,561

(22) Filed: Nov. 11, 2009

(30) Foreign Application Priority Data
Nov. 13, 2008 (JP) 2008-291492

(51) Int. Cl. G03B 27/52; G03B 27/42

(52) U.S. Cl. 355/30; 355/53; 355/77

(57) ABSTRACT

An exposure apparatus for exposing a substrate to radiant energy, the substrate being conveyed from a processing apparatus including a coater that coats the substrate with a photoresist and an auxiliary regulator that regulates a temperature of the substrate, the exposure apparatus comprising a measurement device configured to measure the temperature of the substrate, a main regulator configured to regulate a temperature of the substrate prior to exposure of the substrate based on an output from the measurement device, and a controller configured to determine temperature control information used to control regulation of the temperature of the substrate in the auxiliary regulator based on an output from the measurement device, and to transmit the determined temperature control information to the processing apparatus.

### BACKGROUND OF THE INVENTION

1. Field of the Invention

The present invention relates to an exposure apparatus, a substrate processing apparatus, a lithography system including the exposure apparatus and the substrate processing apparatus, and a method of manufacturing a device using the exposure apparatus.

2. Description of the Related Art

A lithography process for manufacturing a semiconductor device can include a coating process, exposure process, and development process. In the coating process, a substrate such as a wafer or a glass plate is coated with a photoresist (resist). In the exposure process, the substrate coated with the photoresist is exposed to radiant energy such as light to form a latent pattern in the coated photoresist. In the development process, the exposed substrate is developed to form a pattern of a mask, to be used for a later process, from the exposed photoresist. A coating and developing apparatus typically performs the coating process and the development process. A substrate coated with a photoresist by the coating and developing apparatus can be conveyed to and exposed by an exposure apparatus. After that, the substrate can be again returned to and developed by the coating and developing apparatus.

If the substrate has a nonuniform temperature distribution, this generates strain in the substrate. Strain of the substrate makes it impossible to form a pattern having a target line width on the substrate, and, additionally, lowers the overlay accuracy regardless of how excellent the resolution of a projection optical system of an exposure apparatus is.

Japanese Patent Laid-Open No. 2002-83756 relates to a temperature regulating apparatus. This patent reference describes that the temperature regulating apparatus measures the temperature of a temperature regulating means, and determines the substrate temperature regulation time based on the measured temperature.

Japanese Patent Laid-Open No. 2003-142386 relates to a substrate temperature regulating apparatus which regulates a substrate to have a final target controlled temperature by bringing the substrate temperature close to a control target temperature. This patent reference describes that the substrate temperature regulating apparatus changes the control target temperature by taking account of the substrate temperature.

Note that a substrate whose temperature is largely different from a target temperature may be conveyed to the substrate temperature regulating apparatus described in each of Japanese Patent Laid-Open Nos. 2002-83756 and 2003-142386. When a substrate having such a temperature is conveyed, it takes a long time to regulate its temperature.

### SUMMARY OF THE INVENTION

One of the aspects of the present invention provides an exposure apparatus for exposing a substrate to radiant energy, the substrate being conveyed from a processing apparatus including a coater that coats the substrate with a photoresist and an auxiliary regulator that regulates a temperature of the substrate, the exposure apparatus comprising a measurement device configured to measure the temperature of the substrate, a main regulator configured to regulate a temperature of the substrate prior to exposure of the substrate based on an output from the measurement device, and a controller configured to determine temperature control information used to control regulation of the temperature of the substrate in the auxiliary regulator based on the output from the measurement device, and to transmit the determined temperature control information to the processing apparatus.

Further features of the present invention will become apparent from the following description of exemplary embodiments with reference to the attached drawings.

### BRIEF DESCRIPTION OF THE DRAWINGS

FIG. 1 is a side view showing the schematic arrangement of a substrate temperature regulating apparatus according to an embodiment of the present invention;

FIG. 2 is a graph illustrating changes in temperature of a substrate and a plate of a temperature regulating unit;

FIG. 3 is a graph illustrating changes in temperature of a substrate and the plate of the temperature regulating unit;

FIG. 4 is a block diagram showing the schematic configuration of a lithography system according to an embodiment of the present invention;

FIG. 5 is a perspective view showing the schematic arrangement of an exposure unit in an exposure apparatus according to an embodiment of the present invention; and

FIG. 6 is a block diagram showing the schematic configuration of a lithography system according to an embodiment of the present invention from an aspect different from that in FIG. 4.

### DESCRIPTION OF THE EMBODIMENTS

Embodiments of the present invention will be described below with reference to the accompanying drawings.

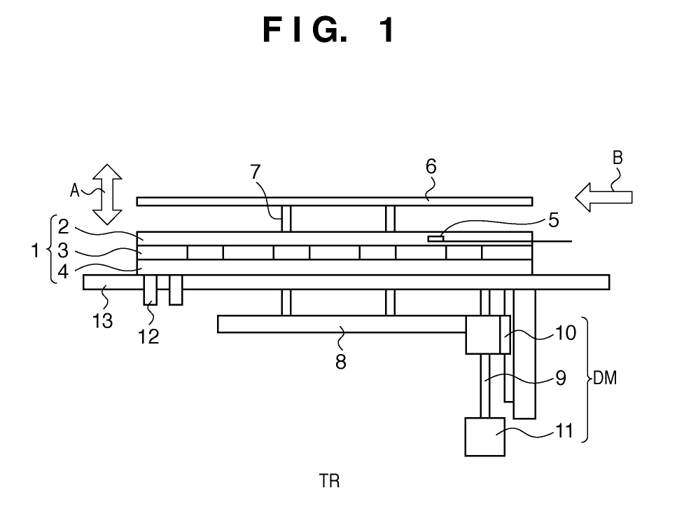

FIG. 1 is a side view showing the schematic arrangement of a substrate temperature regulating apparatus according to an embodiment of the present invention. A substrate temperature regulating apparatus TR shown in FIG. 1 includes a temperature regulating unit 1 which regulates the temperature of a substrate (e.g., a wafer or a glass plate) 6. The temperature regulating unit 1 includes, for example, a plate 2, temperature regulating elements (e.g., Peltier elements) 3, and a heat radiating layer 4. The temperature regulating elements 3 regulate the temperature of the substrate 6 through the plate 2. The heat radiating layer 4 dissipates heat generated by the temperature regulating elements 3. The temperature regulating unit 1 can be supported by, for example, a support body 13. The substrate temperature regulating apparatus TR also includes a measurement device (temperature sensor) 5 which measures the temperature of the substrate 6. The measurement device 5 can be embedded in, for example, the plate 2.

The temperature regulating element 3 has a first surface (upper surface) bonded to the plate 2, and a second surface (lower surface) bonded to the heat radiating layer 4. Heat dissipated by the temperature regulating element 3 is exhausted outside the temperature regulating unit 1 by the fluid flowing through a heat radiating pipe 12 inserted in the heat radiating layer 4. In this embodiment, a plurality of temperature regulating elements 3 are arrayed in one plane. The plate 2 has an effect of uniforming the temperature distribution within the plane in which the plurality of temperature regulating elements 3 are arrayed.

The substrate temperature regulating apparatus TR can include a lift mechanism which lifts/lowers the substrate 6. The lift mechanism includes, for example, a plurality of (e.g., three) lift pins 7, a pin support table 8, and a driving mechanism DM. The lift pins 7 penetrate through the temperature regulating unit 1. The pin support table 8 supports the plurality of lift pins 7. The driving mechanism DM lifts/lowers the plurality of lift pins 7 by lifting/lowering the pin support table 8. The driving mechanism DM includes, for example, a feed screw mechanism 9, motor 11, and linear guide 10. The feed screw mechanism 9 includes a movable portion connected to the pin support table 8. The motor 11 rotates the screw of the feed screw mechanism 9. The linear guide 10 guides the movable portion of the feed screw mechanism 9.

The substrate 6 is mounted on the plurality of lift pins 7 while they project from the plate 2. The substrate 6 is supported by the plate 2 after the plurality of lift pins 7 lower. In removing the substrate 6 from the position on the plate 2, the plurality of lift pins 7 lift so as to form a gap between the lower surface of the substrate 6 and the upper surface of the plate 2. The driving mechanism DM drives the lift pins 7 in this way.

The lower surface of the substrate 6 may directly come into contact with the surface of the plate 2. Alternatively, a small gap (clearance) may be formed between the substrate 6 and the plate 2 by setting minute pins or proximity balls on the plate 2.

A case in which the temperature of the substrate 6 is higher than that of the plate 2 will be considered as one example. Upon mounting the substrate 6 on the plate 2, heat in the substrate 6 gradually transfers to the plate 2, so the temperature of the plate 2 rises. The measurement device 5 measures a rise in temperature of the plate 2. A compensator (not shown) PID-controls the temperature regulating elements 3 so that the output from the measurement device 5, which represents the temperature of the plate 2, becomes constant. If the temperature regulating elements 3 are Peltier elements, the compensator can PID-control the value of a current supplied to the Peltier elements. When the Peltier elements deprive the plate 2 of heat, the temperature of the substrate 6 converges within a target temperature range, together with that of the plate 2.

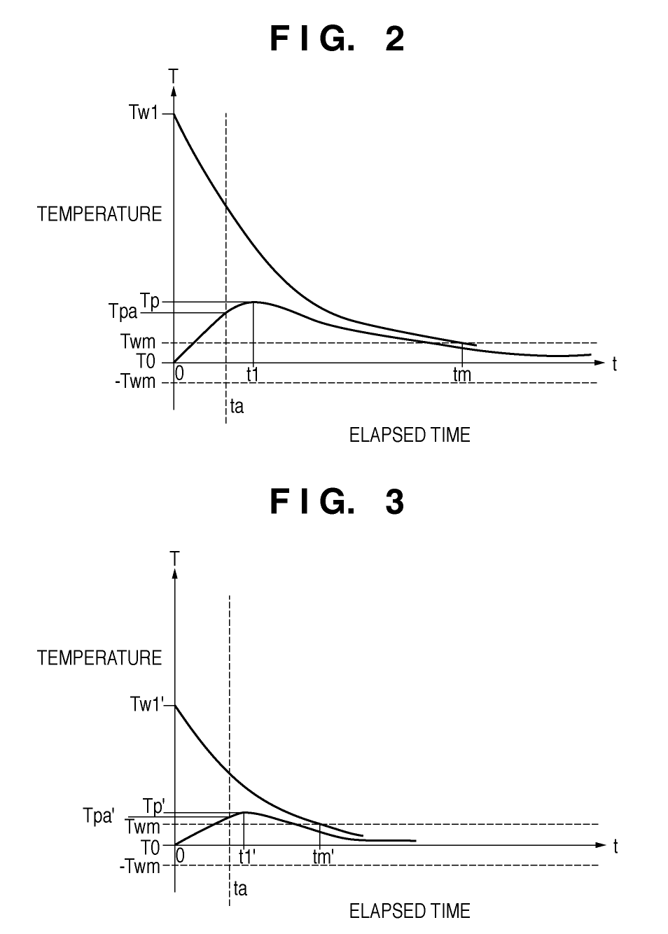

FIG. 2 is a graph illustrating changes in temperature of the substrate 6 and plate 2. In this graph, the abscissa indicates the elapsed time, and the ordinate indicates the temperature. An elapsed time t=0 on the abscissa corresponds to the time when the substrate 6 is mounted on the plate 2 of the temperature regulating unit 1. A temperature T0 on the ordinate is both the target temperature of the substrate 6, and the temperature of the plate 2 the moment the substrate 6 is mounted on the plate 2. A temperature Tw1 is the temperature of the substrate 6 immediately before it is mounted on the plate 2. After the substrate 6 is mounted on the plate 2, heat in the substrate 6 gradually transfers to the plate 2. When an elapsed time t=t1 sec, the temperature of the plate 2 has risen up to a maximum temperature Tp. After that, the temperatures of the plate 2 and substrate 6 gradually drop. The substrate 6 has been mounted on the plate 2 for a time longer than a time t=tm [sec] elapsed until the temperature of the substrate 6 falls within a target temperature range T0±Twm [°]. The temperature regulation of the substrate 6 can thus be completed.

Such a change in temperature of the plate 2 is determined by, for example, the initial temperature Tw1 of the substrate 6, the initial temperature T0 of the plate 2, the heat transfer between the substrate 6 and the plate 2, and the absorption of heat in the temperature regulating elements 3 from the lower surface of the plate 2. That is, a change in temperature of the plate 2 can be estimated by measuring a temperature Tpa of the plate 2 to [sec] after the substrate 6 is mounted on the plate 2. This makes it possible to measure (estimate) the initial temperature Tw1 of the substrate 6 based on the graph of a change in temperature of the plate 2. This, in turn, makes it possible to determine the time tm until the temperature of the substrate 6 falls within the target temperature range T0±Twm [°].

FIG. 3 illustrates changes in temperature of the substrate 6 and the plate 2 when a substrate 6 having a temperature Tw1′ (<Tw1) is mounted on the plate 2. The temperature behavior is the same as in the case of FIG. 3 when the temperature of the substrate 6 is Tw1. That is, when an elapsed time t=0, a substrate temperature=Tw1′ and a plate temperature=T0. After the substrate 6 is mounted on the plate 2, heat in the substrate 6 gradually transfers to the plate 2. At t=t1′ sec, the temperature of the plate 2 has risen up to a maximum temperature Tp′. After that, the temperatures of the plate 2 and substrate 6 gradually drop. However, the time until the temperature of the substrate 6 falls within the target temperature range T0±Twm [°] in this case is shorter than that when the temperature of the substrate 6 is Tw1 [°]; the temperature of the substrate 6 falls within the target temperature range T0±Twm after a time t=tm′ [sec].

Such a change in temperature of the plate 2 is determined by, for example, the initial temperature Tw1′ of the substrate 6, the initial temperature T0 of the plate 2, the heat transfer between the substrate 6 and the plate 2, and the absorption of heat in the temperature regulating elements 3 from the lower surface of the plate 2, in the same manner as above. Hence, a change in temperature of the plate 2 can be estimated by measuring a temperature Tpa′ of the plate 2 to [sec] after the substrate 6 is mounted on the plate 2. This makes it possible to measure (estimate) the initial temperature Tw1′ of the substrate 6 based on a change in temperature of the plate 2. This, in turn, makes it possible to determine the time tm′ until the temperature of the substrate 6 falls within the target temperature range T0±Twm [°]. The same applies to a case in which the initial temperature Tw1′ of the substrate 6 is lower than the initial temperature T0 of the plate 2. Thus, the substrate temperature regulation time can be determined by measuring the temperature of the plate 2 the time to [sec] after the plate 2 is mounted on the plate 2.

In this manner, the temperature of the substrate 6 can be estimated by measuring the temperature of the plate 2 a predetermined time after the substrate 6 is mounted on the plate 2. This makes it possible to determine the temperature regulation time required for each substrate 6. This, in turn, makes it possible to maximize the processing efficiency of the substrate 6, and to reliably regulate the temperature of the substrate 6.

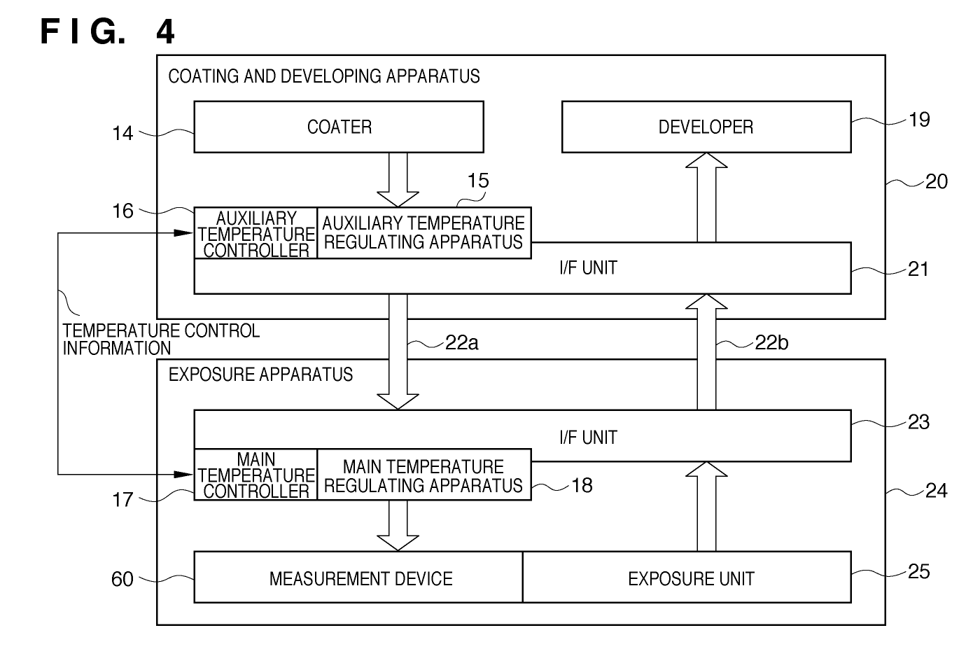

FIG. 4 is a block diagram showing the schematic configuration of a lithography system according to an embodiment of the present invention. This lithography system includes a coating and developing apparatus 20 and exposure apparatus 24. The coating and developing apparatus 20 includes a coater 14 and developer 19. The coater 14 coats a substrate to be conveyed to the exposure apparatus 24 with a photoresist (resist). The developer 19 develops the substrate exposed by the exposure apparatus 24. The coating and developing apparatus 20 exemplifies a substrate processing apparatus including the coater 14 which coats a substrate with a photoresist.

The exposure apparatus 24 projects the pattern of an original (which can also be called a reticle or a mask) onto a substrate (e.g., a wafer or a glass plate) by a projection optical system to expose the substrate.

The coating and developing apparatus 20 includes an auxiliary temperature regulating apparatus 15 and auxiliary temperature controller 16. The auxiliary temperature regulating apparatus 15 can have the same arrangement as that of, for example, the substrate temperature regulating apparatus TR shown in FIG. 1. The auxiliary temperature regulating apparatus 15 regulates the temperature of a substrate 6 to be conveyed from the coating and developing apparatus 20 to the exposure apparatus 24 via an interface unit 21 along a conveyance route 22a. Note that the auxiliary temperature controller 16 controls substrate temperature regulation in a temperature regulating unit (auxiliary temperature regulator) 1 of the auxiliary temperature regulating apparatus 15 based on temperature control information transmitted from a main temperature controller 17 of the exposure apparatus 24. The interface unit 21 feeds a substrate coated with a photoresist in order to convey it to the exposure apparatus 24 along the conveyance route 22a, and receives the exposed substrate conveyed from the exposure apparatus 24 along a conveyance route 22b.

The exposure apparatus 24 includes a measurement device 60 and exposure unit 25. The measurement device 60 measures the characteristics of the substrate conveyed from the coating and developing apparatus 20 along the conveyance route 22a. The exposure unit 25 exposes the substrate while controlling it based on the measurement result obtained by the measurement device 60. The exposure unit 25 projects the pattern of an original onto a substrate (e.g., a wafer or a glass plate) by a projection optical system to expose the substrate. The exposure apparatus 24 may also be configured to parallelly perform a measurement process of one substrate by the measurement device 60, and an exposure process of another substrate by the exposure unit 25. Such an exposure apparatus can include at least two substrate stages.

The exposure apparatus 24 includes a main temperature regulating apparatus 18 and the main temperature controller 17. The main temperature regulating apparatus 18 can have the same arrangement as that of, for example, the substrate temperature regulating apparatus TR shown in FIG. 1. A temperature regulating unit (main temperature regulator) 1 of the main temperature regulating apparatus 18 regulates the temperature of a substrate prior to its exposure by the exposure unit 25. The main temperature controller 17 transmits temperature control information to the auxiliary temperature controller 16 of the coating and developing apparatus 20 to control substrate temperature regulation in the temperature regulating unit (auxiliary temperature regulator) 1 of the auxiliary temperature regulating apparatus 15. The temperature control information is determined based on the output (information representing the substrate temperature) from the measurement device 5 of the main temperature regulating apparatus 18. The main temperature controller 17 also controls the temperature regulating unit (main temperature regulator) 1 of the main temperature regulating apparatus 18 based on the output from the measurement device 5 of the main temperature regulating apparatus 18 to regulate the substrate temperature to fall within a target temperature range. The substrate temperature regulation time in the temperature regulating unit (main temperature regulator) 1 of the main temperature regulating apparatus 18 is determined for each substrate so that the substrate temperature falls within a target temperature range T0±Twm [°].

The exposure apparatus 24 includes an interface unit 23. The interface unit 23 receives a substrate conveyed from the coating and developing apparatus 20 along the conveyance route 22a, and feeds the exposed substrate in order to convey it to the coating and developing apparatus 20 along the conveyance route 22b. A substrate conveyed from the coating and developing apparatus 20 along the conveyance route 22a is supplied to the main temperature regulating apparatus 18 via the interface unit 23.

The main temperature controller 17 and auxiliary temperature controller 16 typically include communication interfaces, and can communicate with each other via their communication interfaces. The communication may also be done using a network such as a LAN. The main temperature controller 17 includes at least a transmitter which transmits temperature control information to the auxiliary temperature controller 16. The auxiliary temperature controller 16 includes at least a receiver which receives the temperature control information transmitted from the main temperature controller 17. The temperature control information can be determined based on, for example, a target temperature and the output from the measurement device 5 of the main temperature regulating apparatus 18.

As is well known to those skilled in the art, transmitting information from a first apparatus to a second apparatus includes transmitting information from the first apparatus to the second apparatus via one or a plurality of apparatuses.

The temperature regulating unit (main temperature regulator) 1 of the main temperature regulating apparatus 18 of the exposure apparatus 24 regulates the temperatures of a plurality of substrates 6. After that, an initial temperature Tw1′ of the substrate 6 conveyed from the coating and developing apparatus 20 can be estimated. The initial temperature Tw1′ can be estimated based on, for example, a temperature Tpa′ of the plate 2, as described above.

Let Twi be the initial temperature of the substrate 6 conveyed from the coating and developing apparatus 20 (the estimated temperature of the substrate 6, conveyed from the coating and developing apparatus 20, immediately before the main temperature regulating apparatus 18 regulates the temperature of the substrate 6). Then, the main temperature controller 17 can estimate the initial temperature Twi of the substrate 6, conveyed from the coating and developing apparatus 20, by statistically processing temperatures Tpa′ of the plate 2 measured by the measurement device 5 for the plurality of substrates 6, respectively. The main temperature controller 17 can calculate the difference between the initial temperature Twi and a target temperature range T0, that is, an offset value Twofs of the initial temperature of the substrate 6, conveyed from the coating and developing apparatus 20, with respect to a target temperature. The main temperature controller 17 preferably transmits information including the offset value Twofs to the auxiliary temperature controller 16 of the coating and developing apparatus 20 as temperature control information.

The auxiliary temperature controller 16 of the coating and developing apparatus 20 controls the temperature regulating unit (auxiliary temperature regulator) 1 of the auxiliary temperature regulating apparatus 15 based on the temperature control information including the temperature offset value Twofs. This makes it possible to minimize in advance the amount of temperature regulation (Initial Temperature Tw1′−Target Temperature T0) in the temperature regulating unit (main temperature regulator) 1 of the main temperature regulating apparatus 18 of the exposure apparatus 24. In other words, it is possible to shorten a time tm′ until the temperature of the substrate 6 falls within the target temperature range T0±Twm [°].

The auxiliary temperature controller 16 of the coating and developing apparatus 20 controls the substrate temperature by, for example, adjusting the temperature regulating capability of temperature regulating elements 3 or adjusting the temperature regulation time, based on the temperature control information. The temperature regulating capability of the temperature regulating elements 3 can be adjusted by controlling, for example, the magnitude of a current supplied to Peltier elements serving as the temperature regulating elements 3. The coating and developing apparatus 20 can regulate the substrate temperature so as to prevent the productivity of the exposure apparatus 24 from lowering due to a delay in substrate conveyance from the coating and developing apparatus 20 to the exposure apparatus 24.

In contrast, assume a conventional lithography system which does not transmit temperature control information from the exposure apparatus 24 to the coating and developing apparatus 20. This lithography system cannot guarantee that a substrate whose temperature is regulated to fall within the target temperature range required by the exposure apparatus 24 is always supplied from the coating and developing apparatus 20 to the exposure apparatus 24. One reason for this is that the temperature controller of the coating and developing apparatus cannot sense the temperature of a substrate the moment it is conveyed to the exposure apparatus. Another reason is that the temperature controller cannot sense an environmental change of the conveyance route from the coating and developing apparatus and the exposure apparatus.

Substrate temperature regulation is not limited to a method of controlling a current supplied to Peltier elements. Instead, this regulation may exploit a method of controlling the gap between the plate 2 and the substrate 6, a method of supplying a temperature regulating fluid into the plate 2, or another method.

The measurement device 5 may be one which also serves to control the temperature of the plate 2, or one dedicated to substrate temperature measurement. A change in temperature of the plate 2 can be measured over a wider range by placing a dedicated temperature sensor within the plane of the plate 2. This makes it possible to more precisely regulate the temperature of the substrate 6.

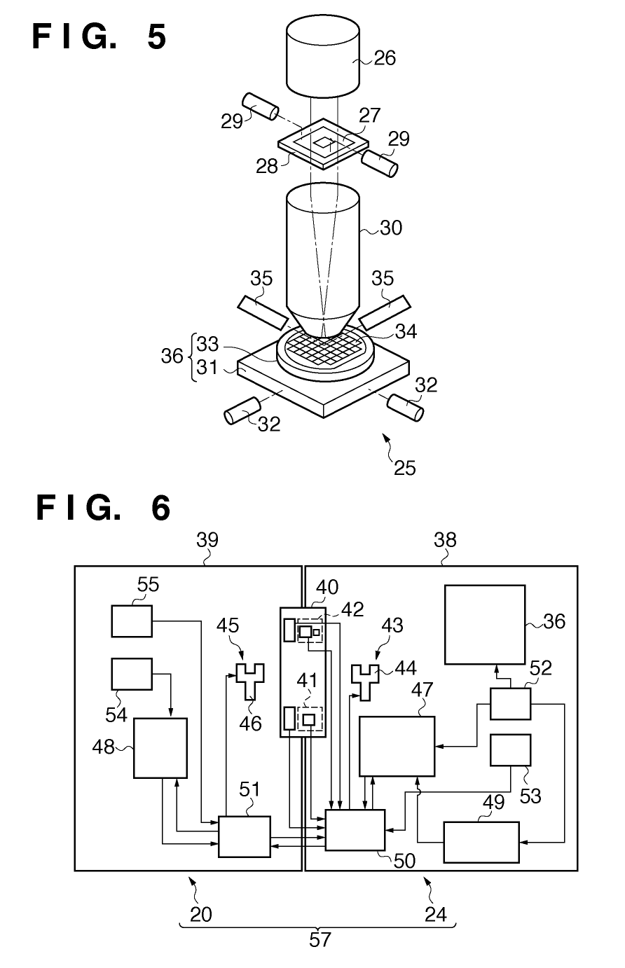

FIG. 5 is a perspective view showing the schematic arrangement of an exposure unit 25 in an exposure apparatus 24 according to an embodiment of the present invention. The exposure unit 25 includes an illumination device 26, original stage 28, and position measurement units 29. The illumination device 26 includes a light source. The original stage 28 holds an original 27 having a pattern formed on it. The position measurement units 29 measure the positions of the original 27 held by the original stage 28. The exposure unit 25 also includes a projection optical system 30 and stage mechanism 36. The stage mechanism 36 positions a substrate (wafer) 34 coated with a photoresist. The stage mechanism 36 includes an X-Y stage mechanism 31 and Z stage mechanism 33. The X-Y stage mechanism 31 positions the substrate 34 in the X and Y directions. The Z stage mechanism 33 positions the substrate 34 in the Z direction. The exposure unit 25 also includes a laser interferometer 32 and focus unit 35. The laser interferometer 32 measures the position of the X-Y stage mechanism 31 in the X and Y directions. The focus unit 35 measures the position of the substrate 34 in the Z direction. The pattern formed on the original 27 is projected onto the substrate 34 on the Z stage mechanism 33 via the projection optical system 30 to form a latent image pattern on the photoresist applied on the substrate 34. This latent image pattern is visualized into a physical pattern upon being developed by a developing apparatus.

FIG. 6 is a block diagram showing the schematic configuration of a lithography system according to an embodiment of the present invention from an aspect different from that in FIG. 4. A lithography system 57 shown in FIG. 6 includes an exposure apparatus 24 including an exposure unit 25 as shown in FIG. 5, and a coating and developing apparatus (substrate processing apparatus) 20. The exposure apparatus 24 includes an exposure chamber 38. The exposure chamber 38 accommodates the exposure unit 25 as the main part of the exposure apparatus 24. For the sake of simplicity, FIG. 6 only shows a stage mechanism 36 as the exposure unit 25 in the exposure apparatus 24. The exposure chamber 38 accommodates a first conveyance unit 43 serving as a conveyance unit on the exposure apparatus side, an exposure apparatus controller 47, and an input/output device 49 serving as a user interface.

The first conveyance unit 43 includes a hand 44 which holds the substrate 34. The exposure chamber 38 also accommodates a main power supply 52, an auxiliary power supply 53, and a first conveyance controller 50 which controls the first conveyance unit 43. The main power supply 52 supplies power to at least the exposure unit 25, exposure apparatus controller 47, and input/output device 49. The auxiliary power supply 53 supplies power to the first conveyance controller 50. The auxiliary power supply 53 is configured to continue supplying power to its power supply target even when the power supply by the main power supply 52 to its power supply targets is cut off. More specifically, the auxiliary power supply 53 can include, for example, a secondary battery. If the main power supply 52 is normal, the auxiliary power supply 53 charges the secondary battery using power supplied from the main power supply 52. If the power supply by the main power supply 52 is cut off due to, for example, an abnormality of the main power supply 52 or a power failure, the secondary battery supplies power to its power supply target.

The coating and developing apparatus 20 includes a coating and developing chamber 39. The coating and developing chamber 39 accommodates the main part of the coating and developing apparatus 20 (that main part includes a coater 14 and developer 19). The coating and developing chamber 39 also accommodates a second conveyance unit 45 serving as a conveyance unit on the coating and developing apparatus side, and a coating and developing apparatus controller 48. The coating and developing chamber 39 also accommodates a main power supply 54, an auxiliary power supply 55, and a second conveyance controller 51 which controls the second conveyance unit 45. The second conveyance unit 45 includes a hand 46 which holds a substrate 34. The main power supply 54 supplies power to at least the main part of the coating and developing apparatus 20, and the coating and developing apparatus controller 48. The auxiliary power supply 55 supplies power to the second conveyance controller 51.

The auxiliary power supply 55 is configured to continue supplying power to its power supply target even when the power supply by the main power supply 54 to its power supply targets is cut off. More specifically, the auxiliary power supply 55 can include, for example, a secondary battery. If the main power supply 54 is normal, the auxiliary power supply 55 charges the secondary battery using power supplied from the main power supply 54. If the power supply by the main power supply 54 is cut off due to, for example, an abnormality of the main power supply 54 or a power failure, the secondary battery supplies power to its power supply target.

The first conveyance unit 43 receives the substrate conveyed to a loading unit 41 in a transfer station 40 by the second conveyance unit 45, and conveys it to the stage mechanism 36 of the exposure unit 25. The first conveyance unit 43 conveys the exposed substrate to an unloading unit 42 in the transfer station 40. The first conveyance unit 43 often conveys the substrate to the X-Y stage mechanism 31 via an alignment unit. The exposure chamber 38 often accommodates a plurality of conveyance units.

A method of manufacturing devices (e.g., a semiconductor device and a liquid crystal display device) according to one embodiment of the present invention will be explained next.

A semiconductor device is manufactured by a preprocess of forming an integrated circuit on a wafer (semiconductor substrate), and a post-process of completing, as a product, a chip of the integrated circuit formed on the wafer by the preprocess. The preprocess can include a step of exposing a wafer coated with a photoresist using the above-mentioned exposure apparatus, and a step of developing the wafer. The post-process can include an assembly step (dicing and bonding) and packaging step (encapsulation). Also, a liquid crystal display device is manufactured by a step of forming a transparent electrode. The step of forming a transparent electrode can include a step of coating a glass substrate, on which a transparent conductive film is deposited, with a photoresist, a step of exposing the glass substrate coated with the photoresist using the above-mentioned exposure apparatus, and a step of developing the glass substrate.

The device manufacturing method according to this embodiment is more advantageous in at least one of the productivity and quality of devices than the prior arts.

Although preferred embodiments of the present invention have been described above, the present invention is not limited to these embodiments, and various modifications and changes can be made without departing from the spirit and scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-291492, filed Nov. 13, 2008, which is hereby incorporated by reference herein in its entirety.

What is claimed is:

1. An exposure apparatus for exposing a substrate to radiant energy, the substrate being conveyed from a processing apparatus including a coater that coats the substrate with a photoresist and an auxiliary regulator that regulates a temperature of the substrate, the exposure apparatus comprising:
a measurement device configured to measure the temperature of the substrate;
a main regulator configured to regulate the temperature of the substrate prior to exposure of the substrate based on an output from the measurement device; and
a controller configured to determine temperature control information used to control regulation of the temperature of the substrate in the auxiliary regulator based on an output from the measurement device, and to transmit the determined temperature control information to the processing apparatus.

2. The apparatus according to claim 1, wherein the controller is configured to determine the temperature control information based on the output and a target temperature of the substrate.

3. The apparatus according to claim 1, wherein
the main regulator includes a plate, and is configured to regulate the temperature of the substrate by regulation of a temperature of the plate.

4. The apparatus according to claim 3, wherein
the measurement device includes a sensor configured to measure the temperature of the plate, and is configured to obtain an initial temperature of the substrate based on a change in output from the sensor.

5. The apparatus according to claim 4, wherein
the temperature control information includes information representing a difference between the obtained initial temperature and a target temperature of the substrate.

6. The apparatus according to claim 1, wherein the controller is further configured to control regulation of the temperature of the substrate in the main regulator.

7. A system including a processing apparatus and an exposure apparatus, the processing apparatus including a coater which coats a substrate with a photoresist and an auxiliary regulator which regulates a temperature of the substrate, the exposure apparatus being configured to expose the substrate conveyed from the processing apparatus to radiant energy,
the exposure apparatus including
a measurement device configured to measure the temperature of the substrate conveyed from the processing apparatus,
a main regulator configured to regulate the temperature of the substrate prior to exposure of the substrate based on an output from the measurement device, and
a first controller configured to determine temperature control information used to control regulation of the temperature of the substrate in the auxiliary regulator based on an output from the measurement device, and to transmit the determined temperature control information to the processing apparatus, and
the processing apparatus including
a second controller configured to control regulation of the temperature of the substrate in the auxiliary regulator based on the temperature control information transmitted from the exposure apparatus.

8. A processing apparatus including a coater which coats a substrate with a photoresist, the substrate being conveyed to an exposure apparatus for exposing the substrate to radiant energy, the processing apparatus comprising:
a regulator configured to regulate a temperature of the substrate; and
a controller configured to control regulation of the temperature of the substrate in the regulator based on temperature control information transmitted from the exposure apparatus.

9. A processing apparatus including a coater which coats a substrate with a photoresist, the substrate being conveyed to an exposure apparatus for exposing the substrate to radiant energy, the processing apparatus comprising:
an auxiliary regulator configured to regulate a temperature of the substrate; and
a first controller configured to control regulation of the temperature of the substrate in the auxiliary regulator based on temperature control information transmitted from the exposure apparatus, and
the exposure apparatus including
a measurement device configured to measure the temperature of the substrate,
a main regulator configured to regulate the temperature of the substrate prior to exposure of the substrate based on an output from the measurement device, and
a second controller configured to determine the temperature control information based on an output from the measurement device, and to transmit the determined temperature control information to the processing apparatus.

10. A method comprising:
exposing a substrate to radiant energy using an exposure apparatus; and
developing the exposed substrate; and
processing the developed substrate to manufacture a device,
wherein the substrate is conveyed from a processing apparatus to the exposure apparatus, the processing apparatus including a coater that coats the substrate with a photoresist and an auxiliary regulator that regulates a temperature of the substrate, the exposure apparatus including
a measurement device configured to measure the temperature of the substrate;
a main regulator configured to regulate the temperature of the substrate prior to exposure of the substrate based on an output from the measurement device; and
a controller configured to determine temperature control information used to control regulation of the temperature of the substrate in the auxiliary regulator based on an output from the measurement device, and to transmit the determined temperature control information to the processing apparatus.

11. The method according to claim 10, wherein the controller is configured to determine the temperature control information based on the output and a target temperature of the substrate.

12. The method according to claim 10, wherein
the main regulator includes a plate, and is configured to regulate the temperature of the substrate by regulation of a temperature of the plate.

13. The method according to claim 12, wherein
the measurement device includes a sensor configured to measure the temperature of the plate, and is configured to obtain an initial temperature of the substrate based on a change in output from the sensor.

14. The method according to claim 13, wherein
the temperature control information includes information representing a difference between the obtained initial temperature and a target temperature of the substrate.

15. The method according to claim 10, wherein the controller is further configured to control regulation of the temperature of the substrate in the main regulator.
